(19) United States
(12) Patent Application Publication
(10) Pub. No.: US 2011/0096864 A1
(43) Pub. Date: Apr. 28, 2011

(54) PROGRAMMABLE DIGITAL CLOCK CONTROL SCHEME TO MINIMIZE SPUR EFFECT ON A RECEIVER

(75) Inventor: Shuang Yu, Carlsbad, CA (US)

(73) Assignee: MaxLinear, Inc., Carlsbad, CA (US)

(21) Appl. No.: 12/913,732

(22) Filed: Oct. 27, 2010

Related U.S. Application Data
(60) Provisional application No. 61/255,784, filed on Oct. 28, 2009.

(51) Int. Cl. H04L 27/00

(52) U.S. Cl. 375/295

(57) ABSTRACT

A device includes an analog front end for receiving a radio frequency (RF) signal. The analog front end contains a local oscillator that is tuned to a local oscillation frequency for down-converting the received RF signal to a first intermediate frequency (IF) signal. An analog-to-digital converter module converts the first IF signal to a digital baseband signal. The device also includes a digital processing unit for processing the baseband signal. The digital processing unit generates multiple clock signals from a reference oscillator having digitally adjustable reference frequency. The reference frequency and the multiple clock signals may interfere with the local oscillator and generate several frequency spurs that may fall within the bandwidth of the received RF signal. In a preferred embodiment, the digital processing unit adjusts the reference frequency by a certain amount so that the spurs do not fall within the RF signal bandwidth.

### CROSS-REFERENCES TO RELATED APPLICATIONS

The present application claims benefit under 35 USC 119(e) of U.S. provisional application No. 61/255,784, filed Oct. 28, 2009, entitled “Programmable Digital Clock Control Scheme to Minimize Spur Effect on a Receiver,” the content of which is incorporated herein by reference in its entirety.

### BACKGROUND OF THE INVENTION

The present invention relates to radio frequency communication systems, and more particularly to techniques that eliminate or avoid spurs in such systems.

Manufacturers of handsets and consumer devices continue to pack more features into a small form factor. The compactness of printed circuit boards is made possible with an increase in integrated circuit density far beyond what was originally imagined.

Increasing circuit density has not only improved the complexity and performance of integrated circuits, but also provided lower costs to the consumer. For example, current smart phones incorporate voice and data functionality, GPS, Bluetooth, Wi-Fi, cameras, music players, motion sensors, cameras, FM radio receivers, storage cards, and many other features.

Ever thinner and smaller cellular handsets now provide free navigation services, e.g., Google Android phones and Apple iPhones. That means, different communications technologies and topologies must be placed in closer proximity to each other in a printed circuit board or incorporated in a single integrated circuit. Different communication technologies operate at different radio frequencies, and their proximity to each other will cause interferences. Therefore, the integration of those different radio frequency (RF) technologies requires engineering planning in order to minimize interference between radio subsystems. For example, transmissions in 825 MHz cellular band can mix with Bluetooth or Wi-Fi transmissions at 2400 MHz to produce an intermodulation product at 1575 MHz, right in the GPS receive band. And system clock frequencies must be chosen so that none of them fall within the FM receive band or television channels.

Spurious levels on the output of a phase-locked loop (PLL) that generates a local oscillation frequency for down-mixing a carrier signal are an important design specification in many RF receiver systems. Spurs may come from a variety of sources, one of them is the PLL's reference oscillator. This spur is referred to as the reference spur that can be seen in the PLL's output frequency spectrum, offset from the PLL's output frequency F_{PLL} by ±F_{ref} because many of the PLL's components including the phase-frequency detector (PFD) and charge pump (CP) are clocked at this reference oscillation frequency. A mismatch of the up current source and the down current source in the charge pump is often the major source of reference spur.

Keeping spurious products off local oscillation signal is a challenge. The gain of GPS receivers is generally more than 100 dB to amplify very weak GPS signals to a usable level. Due to the high gain, a tiny spurious product on a local oscillator can have an effect of tuning in an undesired cellular transmitter. For example, a spurious product offset 135 MHz will tune a cellular transmitter at 1710 MHz down to 1575 MHz, again in the GPS band.

Multiple clock signals generated from a same clock frequency source may cause spurs. A system generally requires multiple clock signals that are derived from the same clock source. For example, an analog-to-digital converter (ADC) may need to be sampled at 100 MHz while an ASIC or FPGA requires a clock at 75 MHz. Rising and falling edges of these two clocks occur at nearly the same time. The crosstalk effect of these two clocks may result in jitter and noise spur that may corrupt the ADC timing. The cross-talk effect can be reduced or eliminated by spreading, i.e., delaying the two clocks apart in time.

Television tuners can be sources of spurs that may be generated by mixing of local oscillators with harmonics of system clocks through interference.

From the above, techniques of eliminating or avoiding spurs are desired.

### BRIEF SUMMARY OF THE INVENTION

According to the present invention, techniques for eliminating spurs in a receiver are provided. More particularly, the invention provides systems and methods of eliminating spurs using a spur suppression technique by adjusting a reference oscillator frequency. But it would be recognized that the invention has a much broader range of applicability.

In an embodiment, the present invention provides a device (e.g., an integrated circuit) for eliminating spurs. The device includes an analog front end for receiving a radio frequency (RF) signal. The analog front end contains a local oscillator that is tuned to a local oscillation frequency for down-converting the received RF signal to a first intermediate frequency (IF) signal. An analog-to-digital converter module converts the first IF signal to a digital baseband signal. The device also includes a digital processing unit that is configured to process the baseband signal. The digital processing unit is coupled to a reference oscillator that has a digitally controllable reference frequency. The device may include a clock generator circuit that generates multiple clock signals from the reference frequency. The reference frequency and the multiple clock signals may interfere with the local oscillator and generate several frequency spurs that may fall within the bandwidth of the received RF signal. In a preferred embodiment, the digital processing unit adjusts the reference frequency by a certain amount so that the associated spurs do not fall within the RF signal bandwidth.

In another embodiment, the present invention provides a receiver system that eliminates spurs. The receiver system includes a television tuner that has an RF front end for receiving a television channel and down-converting the channel to an IF signal. The receiver system also includes an analog-to-digital interface that converts the IF signal to a digital baseband signal. The receiver system further includes a digital processing unit having a clock generation circuit that generates a plurality of clock signals from a reference clock frequency. In addition, the digital processing unit determines whether a plurality of spurs are present in a bandwidth of the received television channel and adjusts the reference clock frequency by a frequency amount so that none of the spurs falls within the received television channel bandwidth.

In yet another embodiment, the present invention provides a method of eliminating spurs in a tuner that includes a local oscillator having a local oscillator frequency, an analog-to-digital converter module, and a digital processing unit that operates with a plurality of clock signals generated from a reference frequency. The method includes receiving a radio frequency signal and determining whether at least one spur is present in a bandwidth of the received RF signal. The method further includes adjusting the reference frequency such that the at least one spur falls outside the RF signal bandwidth. In addition, the method includes converting the radio frequency signal to a digital baseband signal and processing the digital baseband signal with one or more of the plurality of clock signals associated with the adjusted reference frequency. The method further includes compensating the processed baseband signal for the adjusted clock signals. In an embodiment, the method also includes converting the processed digital baseband signal to an IF analog signal for further processing in a demodulator.

### BRIEF DESCRIPTION OF THE DRAWINGS

For a more complete understanding of the present invention, reference is now made to the following descriptions taken in conjunction with the accompanying drawing, in which:

FIG. 1 is a simplified receiver block diagram according to an embodiment of the present invention.

FIG. 2 is a simplified block diagram of a spur suppression circuit according to an embodiment of the present invention.

FIG. 3 is an exemplary schematic block diagram of a clock rate compensation circuit according to an embodiment of the present invention.

FIG. 4 illustrates a method for avoiding spurs according to an embodiment of the present invention.

### DETAILED DESCRIPTION OF THE INVENTION

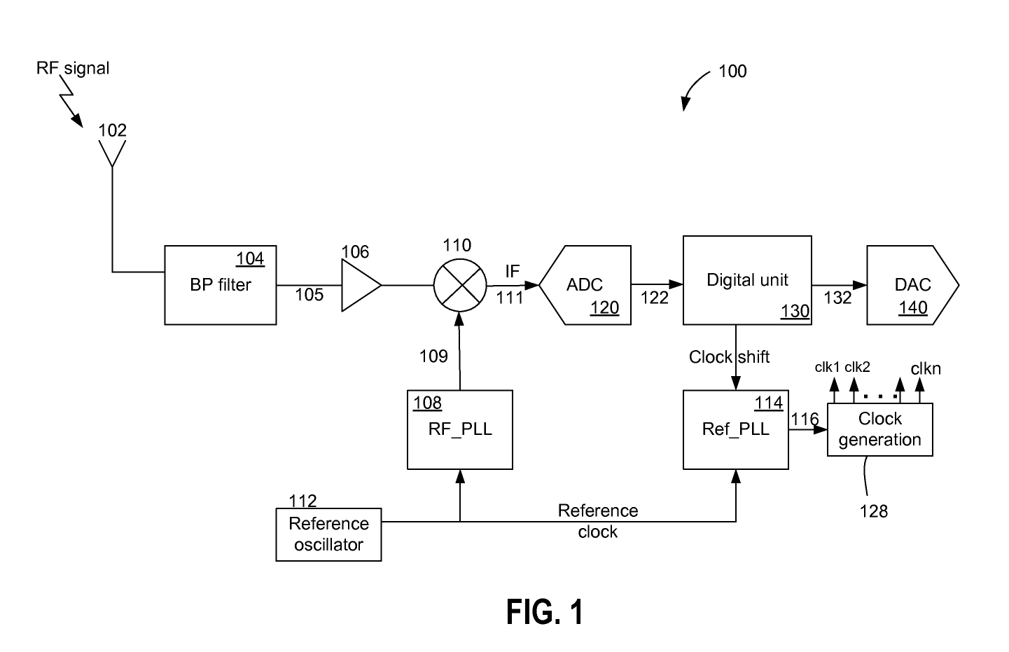

FIG. 1 is a simplified receiver 100 for receiving an RF signal according to an embodiment of the present invention. Receiver 100 includes a band-pass filter 104 that receives the RF signal from an antenna 102 and outputs a filtered RF band signal 105 to a low noise amplifier 106. Low noise amplifier 106 may have variable gain and amplifies the band-pass filtered RF band signal to a level suitable for a subsequent mixer 110. Mixer 110 receives a local oscillation frequency signal 109 from an RF PLL 108 and converts the RF band signal into an intermediate frequency (IF) analog signal 111.

In an embodiment, receiver 100 may be a heterodyne receiver that mixes the RF signal with the local oscillation frequency signal to produce the IF analog signal. The intermediate frequency can be higher in frequency than the bandwidth of the RF signal. In another embodiment, receiver 100 may be a homodyne receiver that has a local oscillation frequency signal being exactly the same frequency as the carrier of the RF signal, so the center frequency of the IF analog signal is at DC. In yet another embodiment, the local oscillation frequency signal of receiver 100 may have a local oscillation frequency with a frequency offset less than the bandwidth of the RF signal, so that the intermediate frequency is in a vicinity of DC or near-DC IF signal.

At this point, the IF analog signal 111 may contain a signal band of interest that is then sampled and digitized by an analog-to-digital converter 120 to a digital baseband signal 122. In the following description, the term baseband signal is to be understood as including the IF signal, the near-zero IF signal or the baseband signal at DC. A digital processing unit 130 processes the digital baseband signal 122 and outputs a processed digital signal 132 to a subsequent digital-to-analog converter 140. The digital processing unit 130 is coupled to a reference PLL 114 that provides a reference system clock 116 to a clock generator circuit 128. Clock generator circuit 128 may generate multiple clock signals that are required to operate different parts of the digital processing unit. The interference between the plurality of clock signals and the local oscillation frequency signal 109 produces multiple spurs that may fall into the RF signal band.

The frequency of each spur relates to the local oscillation frequency signal 109 and the reference system clock 116 can be calculated as:

fspur=p*f₁ₒ−q*f_{ref} (1)

where p and p are integer numbers representing the harmonics of the local oscillator and the reference system clock, respectively.

Similarly, the frequency of each spur relates to the local oscillation frequency signal 109 and each of the derived clock signals clk1, clk2, clkn can be calculated as:

fspur(i)=p*f₁ₒ−q*f_{clk(i)} (2)

where p, and q are integer numbers representing the harmonics of the respective the local oscillator and the ith clock signal.

If any spur falls within the bandwidth of the RF signal of interest, that spur may affect the quality of the resulting IF signal and the associated digitized baseband signal, hence the performance of the receiver.

In an embodiment of the present invention, the RF PLL 108 and the reference PLL 114 share a common reference oscillator 112. In a preferred embodiment, the reference oscillator 112 is a crystal oscillator having a frequency higher than the bandwidth of the modulation information signal, so that the reference spurs at the output 109 of the RF_PLL 108 will be located at a frequency ±f_{ref} apart from f₁ₒ and will fall outside of the signal of interest. In another embodiment, the RF PLL 108 and the reference PLL 114 may not share the common reference oscillator 112.

In an embodiment, mixer 110 may be a complex mixer, so that the IF signal 111 is also a complex signal. The ADC module 120 may include one or more analog-to-digital converters for converting the real or complex IF signal to a digital baseband signal.

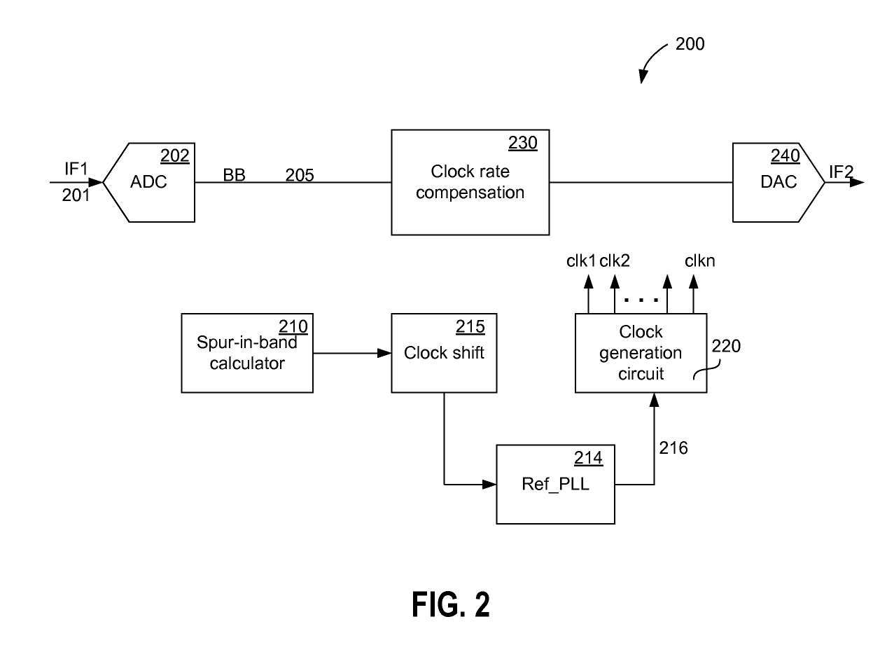

FIG. 2 is a simplified exemplar block diagram of a spur suppression circuit 200 according to an embodiment of the present invention. Spur suppression circuit 200 includes an analog-to-digital converter module 202 that receives an IF signal 201 coming from an RF frontend module and converts it into a digital baseband signal 205. Baseband signal 205 may include a signal band of interest having one or more frequency spurs that are identified by equations (1) and (2). In order to eliminate frequency spurs present in the baseband signal, a spur-in-band calculator circuit 210 may determine an adjustment to a reference PLL 214 that produces a reference frequency. A clock generation circuit 220 receives the reference frequency 216 and generates a plurality of clock signals clk1, clk2, . . . , clkn for the operation of the different parts of digital processing unit 130. Clock generation circuit 220 may include a buffer to amplify the reference frequency and a digital divider, e.g., a binary counter, to derive one or more of clock signals from the buffered reference frequency. In other words, the plurality of clock signals can include the buffered reference frequency and other frequencies derived therefrom. In an embodiment, the spur-in-band calculator circuit issues an instruction to a clock shift circuit 215 that causes a frequency adjustment to the reference frequency 216 of reference PLL 214.

In an embodiment, spur-in-band calculator 210 may determine a priori spurs that are associated with a given local oscillation frequency and the amount of frequency that needs to be shifted from a nominal value of the reference frequency. The data can be stored in a memory that is accessible to the clock shift circuit 215, so that the clock shift circuit can adjust the frequency of the reference PLL 214 based on the selected RF channel or based on the value of the local oscillation frequency.

Also shown in FIG. 2, a clock rate compensation circuit 230 is configured to compensate for the adjusted reference frequency and the associated clock signals due to the change or shift from its nominal value of reference frequency 216. The following numerical example illustrates an embodiment of the present invention. For example, the RF signal has a carrier frequency of 502 MHz and a modulation bandwidth of 8 MHz. If the reference frequency 216 (or signal 116 in FIG. 1) has a nominal frequency value of 100 MHz, its 5^{th} harmonic is 500 MHz, which falls within the bandwidth of the RF signal (502 MHz±4 MHz=498 MHz to 506 MHz). To avoid this 5^{th} harmonic from interfering with the processing of the RF signal, the spur-in-band calculator instructs the reference PLL 214 via clock shift circuit 215 to adjust the reference frequency 216 down to 99 MHz. Now the 5^{th} harmonic is 495 MHz that is outside of the RF signal bandwidth.

Similarly, spur-in-band calculator 210 may instruct via clock shift circuit 215 the reference PLL to change its reference frequency to 101.5 MHz, so that the 5^{th} harmonic is now 107.5 MHz that also falls outside the RF signal bandwidth.

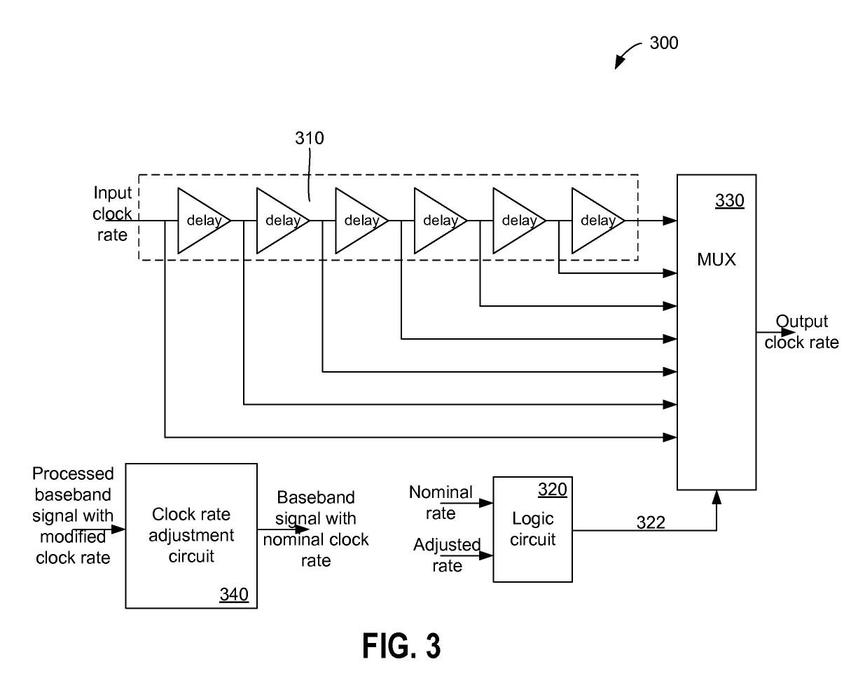

As the reference frequency 216 moves from its nominal value, clock signals clk1, clk2, . . . , clkn will also change proportionally. For example, ADC module 202 may have sampled IF signal 201 at 20 MHz previously (nominal value 100 MHz/5), now its sampling rate is either 19.8 MHz when the reference frequency is moved to down 99 MHz or 20.3 MHz when the reference frequency is moved up to 101.5 MHz. The clock rate change may also affect DAC module 240 in a similar way. The clock rate change can be compensated using several digital techniques. In an embodiment, the nominal frequency value can be regenerated from the adjusted clock frequency using a string of delay elements as shown in FIG. 3. The clock rate compensation will be described in more detail below.

To compensate for the change in the reference frequency, clock rate compensation circuit 230 may perform an interpolation. In the example of a changed reference frequency of 99 MHz instead of the nominal value of 100 MHz, clock rate compensation circuit 230 may generate an additional digital sample every 99 samples by performing a linear interpolation between consecutive samples of the processed baseband signal. In the example of a changed reference frequency of 101.5 MHz, clock rate compensation circuit 230 may suppress 3 digital samples every 203 samples of the processed baseband signal.

In an embodiment, spur suppression circuit 200 may be implemented in hardware, software, or a combination of hardware and software to perform the functions of the spur-in-band calculator, the clock shift circuit, the clock rate compensation, and others. In another embodiment, spur suppression circuit 200 may include a dedicated digital signal processor to perform program codes stored in memory that is integrated on the same semiconductor device as the digital signal processor.

FIG. 3 is an exemplary schematic block diagram of a clock rate compensation circuit 300 according to an embodiment of the present invention. Clock rate compensation circuit 300 includes a delay line 310 having a plurality of selectable delay values, a logic circuit 320, and a multiplex 330 that outputs one of the delayed clocks under the control of a select signal 322 from the state machine. In an embodiment, the plurality of selectable delay values include delay elements that can be implemented using logic gates such as NAND, NOR gates, inverters, or others. State machine 320 outputs the select signal 322 based on information received from the nominal reference frequency and the adjusted reference frequency. Clock rate compensation circuit 300 further includes a logic circuit 340 that receives a baseband signal at an adjusted reference frequency and outputs a baseband signal having a clock rate that is substantially equal to the nominal reference frequency or the associated clock signals. In an embodiment, clock rate adjustment circuit 340 may perform an interpolation between samples of the baseband signal when the adjusted clock rate is lower than the nominal clock rate. In another embodiment, clock rate adjustment circuit 340 may perform a suppression of samples of the baseband signals when the adjusted clock rate is higher than the nominal clock rate.

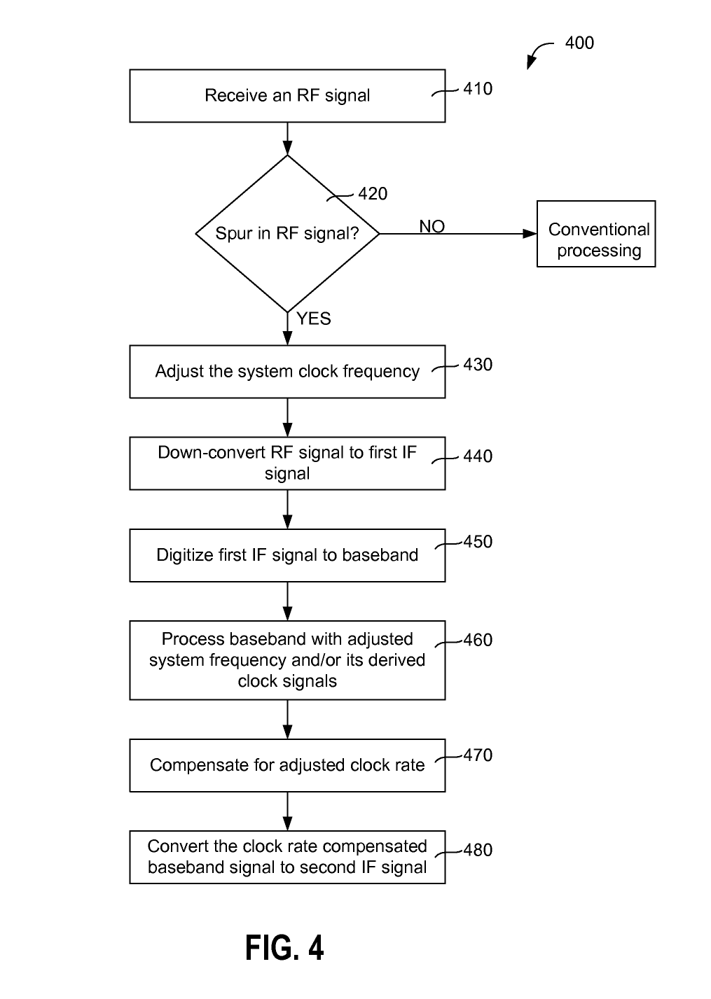

FIG. 4 illustrates a method 400 for avoiding or eliminating spurs according to an embodiment of the present invention. Method 400 includes receiving an RF signal by tuning a system to a desired RF channel (step 410). In an embodiment, the RF channel is a television channel and the RF signal includes a bandwidth containing a television signal. Method 400 further includes determining whether a spur is present within the bandwidth of the RF signal. In the case that a spur is present within the RF signal bandwidth, the system will adjust a system clock frequency having a nominal frequency value by a frequency amount, which can be a positive or a negative value so that the adjusted system clock frequency is less than or greater than the nominal frequency value (step 430). The RF signal is down-converted to a first IF signal (step 440) and digitized to a baseband signal at step 450. In an embodiments, steps 440 and 450 may use the conventional down-mixing and analog-to-digital conversion process. The baseband signal is processed using the adjusted system clock and/or its derived clock signals at step 460. At step 470, the processed baseband signal is re-adjusted to the nominal frequency value using a clock rate compensation scheme so that the processed baseband signal will be output with a clock rate substantial equal to the nominal clock rate corresponding to the nominal frequency. The compensated baseband signal is then converted to a second IF signal using a digital-to-analog interface and sent to a demodulator (step 480). In the event that no spur is present within the bandwidth of the RF signal (“NO” in step 420), the method can process the RF signal using a conventional method without adjusting the system clock frequency (i.e., using the nominal frequency value), which is known to those of skill in the art and not described herein.

The above sequence of steps provides a method of avoiding spurs according to an embodiment of the present invention. Depending on the embodiment, one or more steps may be added, one or more steps may be omitted, and one or more steps may be provided in a different sequence without departing from the scope of the present invention. One of skilled in the art would recognize other variations, modifications, and alternatives.

Embodiments for implementation of the systems and methods of the present invention may comprise a special-purpose or general-purpose processor including hardware and/or software components to carry out or containing processor-executable instructions or data structures to perform the steps disclosed in FIG. 4. Processor-executable instructions include, for example, instructions and data which cause a special-purpose or general-purpose processor to perform a certain step or all of the steps disclosed above. By way of example, and not limitation, the instructions can be program codes stored in memory such as RAM, ROM, EEPROM, or Flash memory.

It is understood that the examples described herein are for illustrative purposes only and that various modifications or changes in light thereof will be suggested to persons skilled in the art and are to be included within the spirit and purview of this application and scope of the appended claims.

What is claimed is:

1. A device comprising:
an analog front end including a first oscillator having a first frequency configured to receive a radio frequency (RF) signal and convert the received RF signal to a digital baseband signal;
a second oscillator having a second frequency; and
a digital processing unit coupled to the analog front end and being configured to generate a plurality of clock signals associated with the second frequency and process the baseband signal using one or more of the plurality of clock signals;
wherein the digital processing unit determines whether at least one spur associated with at least one of the plurality of clock signals falls within a bandwidth of the receive RF signal and adjusts the second frequency in response to a result of the determination of the at least one spur.

2. The device of claim 1 further comprising an analog-to-digital conversion circuit configured to convert the processed baseband signal to an intermediate frequency (IF) analog signal.

3. The device of claim 2, where the IF analog signal comprises a television signal.

4. The device of claim 1, wherein the digital processing unit comprises a clock rate compensation circuit configured to compensate for the adjusted second frequency.

5. The device of claim 1, wherein the adjusted second frequency is lower than a nominal frequency value.

6. The device of claim 1, wherein the adjusted second frequency is higher than the nominal frequency value.

7. The device of claim 1, wherein the second oscillator comprises a phased-locked loop.

8. The device of claim 1, wherein the at least one spur is caused by an interference between the first oscillator and the at least one of the plurality of clock signals.

9. The device of claim 1 further comprising a memory configured to store a plurality of spurs associated with the first frequency.

10. A system comprising:
a tuner including a radio frequency (RF) front end having a first oscillator frequency configured to receive an RF signal and convert the RF signal to a first intermediate frequency (IF) analog signal;
an analog-to-digital converter module configured to convert the first IF analog signal to a digital baseband signal; and
a digital processing unit coupled to a second oscillator frequency and being configured to generate a plurality of clock signals from the second oscillator frequency and process the digital baseband signal using one or more of the plurality of clock signals;
wherein the digital processing unit adjusts the second oscillator frequency so that spurs that are associated with the plurality of clock signals do not fall within a bandwidth of the received RF signal.

11. The system of claim 10 further comprising an analog-to-digital converter module configured to convert the processed digital baseband signal to a second IF analog signal.

12. The system of claim 10, wherein the second oscillator frequency is digitally adjustable.

13. The system of claim 10, wherein the second oscillator frequency is adjusted to a frequency that is higher or lower than a nominal frequency.

14. The system of claim 10, wherein the digital processing unit comprises a clock rate compensation circuit configured to compensate the adjusted second oscillator frequency using interpolation or suppression.

15. The system of claim 10, wherein the digital processing unit comprises a general-purpose processing circuit configured to perform instructions associated with an algorithm that uses the plurality of clock signals and the first oscillator frequency to determine frequency locations of spurs and to adjust the second oscillator frequency based on a result of the determined spur locations.

16. The system of claim 10, wherein the spurs are caused by an interference between the first oscillator frequency and the plurality of clock signals.

17. A method for processing a radio frequency (RF) signal in a tuner system including a local oscillator having a local oscillation frequency, an analog-to-digital converter module, and a digital processing unit including a plurality of clock signals associated with a system frequency, the method comprising:
receiving the RF signal;
determining a presence of at least one spur within a bandwidth of the received RF signal, wherein the at least one spur is caused by an interference between the local oscillation frequency and one of the plurality of clock signals;
adjusting the system frequency such that the at least one spur falls outside the bandwidth of the RF signal;
down-converting the RF signal to a first intermediate frequency (IF) signal;
converting the IF signal to a digital baseband signal; and
processing the digital baseband signal using one or more of the plurality of clock signals associated with the adjusted system frequency.

18. The method of claim 17 further comprising compensating the processed baseband signal for the adjusted system frequency.

19. The method of claim 18 further comprising converting the frequency adjusted baseband signal to a second intermediate frequency analog signal.

20. The method of claim 17, wherein the determining a presence of at least one spur comprises calculating a plurality of interference products associated with the local oscillation frequency and the plurality of clock signals.

21. The method of claim 17, wherein the determining a presence of at least one spur comprises searching in a memory that stores a priori a plurality of spur locations associated with the local oscillation frequency.

22. The method of claim 17, wherein the local oscillation frequency and the system frequency are independent of each other.

23. The method of claim 17, wherein the system frequency is generated by a phase-locked loop.

24. The method of claim 17, wherein the system frequency is digitally adjustable.
